(19) United States
(12) Patent Application Publication
(10) Pub. No.: US 2020/0049982 A1
(43) Pub. Date: Feb. 13, 2020

(54) DISPLAY DEVICE, DISPLAY CONTROL METHOD, AND STORAGE MEDIUM

(71) Applicant: HONDA MOTOR CO., LTD., Tokyo (JP)

(72) Inventors: Masafumi Higashiyama, Wako-shi (JP); Takuya Kimura, Wako-shi (JP); Shinji Kawakami, Wako-shi (JP); Tatsuya Iwasa, Wako-shi (JP); Yuji Kuwashima, Wako-shi (JP)

(21) Appl. No.: 16/519,030

(22) Filed: Jul. 23, 2019

(30) Foreign Application Priority Data
Aug. 7, 2018 (JP) 2018-148333

(51) Int. Cl. G02B 27/01; G09G 5/37

(52) U.S. Cl. CPC G02B 27/0101; G09G 5/37; G02B 27/0149; G02B 2027/0118; G02B 2027/014; G02B 2027/0159; G09G 2354/00

(57) ABSTRACT

A display device includes an image generator configured to output an image, superimpose the image on a landscape, and allow a viewer to visually recognize the image, a receiver configured to receive a suppression instruction for suppressing an output frequency of the image, and a controller configured to cause the image generator to output an event image associated with an event at a timing at which a predetermined event occurs. In a predetermined period, in a case in which the number of times the receiver receives the suppression instruction causing the image generator to output the event image reaches first number of times, the controller suppresses the output frequency of causing the image generator to output the event image regardless of presence or absence of an operation received.

### CROSS-REFERENCE TO RELATED APPLICATION

Priority is claimed on Japanese Patent Application No. 2018-148333, filed Aug. 7, 2018, the content of which is incorporated herein by reference.

### BACKGROUND

### Field

The following embodiments relates to a display device, a display control method, and a storage medium.

### Description of Related Art

In the related art, a head up display (HUD) device that displays an image related to basic information for a driver on a front windshield is known (refer to, for example, Patent Document 1). Using this HUD device, the driver is able to ascertain various pieces of displayed information while maintaining a direction of a line of sight to the front at the time of driving by displaying various marks indicating an obstacle, a reminder, and a progress direction superimposed on a landscape in front of a vehicle (Japanese Unexamined Patent Application First Publication No. 2017-91115).

### SUMMARY

However, in the related art, displaying information may be troublesome for the occupant in some cases.

The following embodiments has been made in consideration of such circumstances and an object of the following embodiments is to provide a display device, a light projection control method, and a storage medium capable of reducing the troublesomeness for an occupant.

A display device, a display control method, and a storage medium according to the aspect adopt the following constitutions.

(1): A display device according to an aspect includes an image generator configured to output an image, superimpose the image on a landscape, and allow a viewer to visually recognize the image, a receiver configured to receive a suppression instruction for suppressing an output frequency of the image, and a controller configured to cause the image generator to output an event image associated with an event at a timing at which a predetermined event occurs, and suppress the output of the event image by the image generator in a case in which the receiver receives the suppression instruction. In a predetermined period, in a case in which the number of times the receiver receives the suppression instruction causing the image generator to output the event image reaches first number of times, the controller suppresses the output frequency of causing the image generator to output the event image regardless of presence or absence of an operation received by the receiver.

(2): In the aspect of (1) described above, the image generator is configured to generate the image that is visually recognized by the viewer by outputting light forming the image by directing incident light toward a reflector that is configured to reflect the light toward eyes of the viewer.

(3): In the aspect of (1) or (2) described above, the controller is configured to refer to correspondence information in which different event images are associated with each of a plurality of types of the events, and cause the image generator to output an event image associated with the type of the generated event, and the number of times the suppression instruction is received is counted for each event image.

(4): In any of the aspects of (1) to (3) described above, the first number of times is different for each event image.

(5): In any of the aspects of (1) to (4) described above, the event includes an event of a first type and an event of a second type, different event images are associated with each type of the event, in the predetermined period, in a case in which the number of times the receiver receives the suppression instruction according to a first timing at which the image generator is caused to output the event image associated with the event of the first type at a timing at which the event of the first type occurs reaches the first number of times, the controller does not suppress the output frequency of causing the image generator to output the event image associated with the event of the first type regardless of the presence or absence of the operation received by the receiver, and in the predetermined period, in a case in which the number of times the receiver receives the suppression instruction according to a second timing at which the image generator is caused to output the event image associated with the event of the second type at a timing at which the event of the second type occurs reaches the first number of times, the controller suppresses the output frequency of causing the image generator to output the event image associated with the event of the second type.

(6): In any of the aspects of (1) to (5) described above, the predetermined period is a period from a time when a drive source of a vehicle is controlled to be in an on state to a time when the drive source is controlled to be in an off state, or a period from the time when the drive source is controlled to be in the on state to a time when a predetermined time elapses from the time when the drive source is controlled to be in the off state.

(7): In any of the aspects of (1) to (6) described above, the image generator includes a projection device configured to output the image as light, an optical mechanism provided on a path of the light and capable of adjusting a distance from a predetermined position to a position where the light is formed as a virtual image, a concave mirror configured to reflect light passing through the optical mechanism toward a reflector, a first actuator configured to adjust the position where the light is formed in the optical mechanism, and a second actuator configured to adjust a reflection angle of the concave mirror.

(8): A display control method using a computer, the computer method comprising: causing an image generator to output an image, superimpose the image on a landscape, and allow a viewer to visually recognize the image to output an event image associated with an event at a timing at which a predetermined event occurs, suppressing the output of the event image by the image generator in a case in which a receiver that receives a suppression instruction for suppressing an output frequency of the image receives the suppression instruction, and suppressing the output frequency of causing the image generator to output the event image regardless of presence or absence of an operation received by the receiver, in a case in which the number of times the receiver receives the suppression instruction causing the image generator to output the event image reaches first number of times, in a predetermined period.

(9): A non-transitory computer-readable storage medium that stores a computer program to be executed by a computer to perform at least: cause an image generator to output an image, superimposes the image on a landscape, and allows a viewer to visually recognize the image to output an event image associated with an event at a timing at which a predetermined event occurs, suppress the output of the event image by the image generator in a case in which a receiver that receives a suppression instruction for suppressing an output frequency of the image receives the suppression instruction, and suppress the output frequency of causing the image generator to output the event image regardless of presence or absence of an operation received by the receiver, in a case in which the number of times the receiver receives the suppression instruction causing the image generator to output the event image reaches first number of times, in a predetermined period.

According to the aspects of (1) to (9), it is possible to reduce troublesomeness for an occupant.

### BRIEF DESCRIPTION OF THE DRAWINGS

FIG. 1 is a diagram of an exemplary example of a constitution of an interior of a vehicle M on which a display device according to an embodiment is mounted.

FIG. 2 is a diagram showing an operation switch of the embodiment.

FIG. 3 is a partial constitution diagram of the display device.

FIG. 4 is a diagram showing a constitution example of the display device centering on a display control device.

FIG. 5 is a diagram showing an example of a content of a correspondence table.

FIG. 6 is a diagram showing an example of an event of a first type and an event of a second type.

FIG. 7 is a flowchart showing a flow of a process executed by the display device of the embodiment.

FIG. 8 is a diagram showing an example of a guidance image VIx displayed at a time of the event of the second type.

FIG. 9 is a diagram showing an example of a control result in a case in which a suppression instruction is performed by an occupant at the time of the event of the second type.

FIG. 10 is a diagram showing an example of an inspection image displayed at a time of the event of the first type.

FIG. 11 is a diagram showing an example of a control result in a case in which the suppression instruction is performed by the occupant at the time of the event of the first type.

FIG. 12 is a diagram showing an example of a content of a correspondence table

FIG. 13 is a diagram showing an example of a first predetermined event and a second predetermined event.

FIG. 14 is a flowchart showing a flow of a process executed by a display device of a second embodiment.

### DETAILED DESCRIPTION

Hereinafter, embodiments of a display device, a display control method, and a storage medium will be described with reference to the drawings. The display device is, for example, a device that is mounted on a vehicle (hereinafter referred to as a vehicle M) and causes an image to be viewed by being superimposed on a landscape. The display device is able to be referred to as a HUD device. As an example, a display device is a device that allows a viewer to visually recognize a virtual image by projecting light including an image on a front windshield of the vehicle M. The viewer is, for example, a driver. The viewer may be a passenger other than the driver. The display device may be implemented by projecting light on a light transmissive display device (for example, a liquid crystal display or an organic electroluminescence (EL) attached to the front windshield of the vehicle M, or a transparent member (a visor or a lens of glasses) of a device worn by a person on a body). The display device may be one to which a light transmissive display device is attached. In the following description, the display device is mounted on the vehicle M, and is a device that projects light including an image on the front windshield.

In the following description, a positional relationship and the like will be described using an XYZ coordinate system as appropriate.

[Overall Constitution]

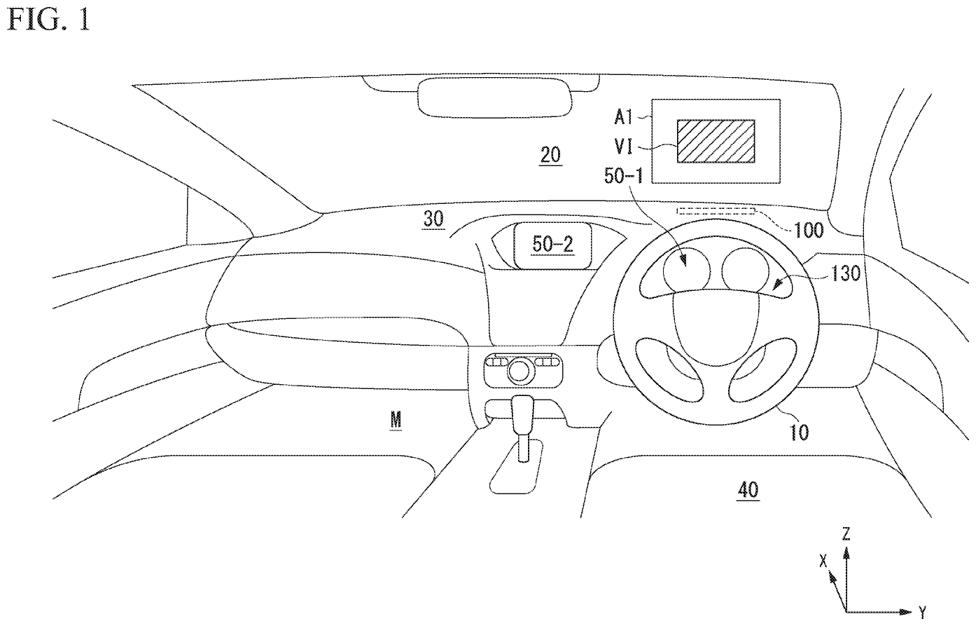

FIG. 1 is a diagram showing an exemplary example of a constitution of an interior of the vehicle M on which a display device 100 according to an embodiment is mounted. The vehicle M is provided with, for example, a steering wheel 10 that controls steering of the vehicle M, a front windshield (an example of a reflector) 20 that divides the interior of the vehicle from the outside of the vehicle, and an instrument panel 30. The front windshield 20 is a member having light transparency. The display device 100 allows the driver sitting in a driver's seat 40 to visually recognize a virtual image VI by, for example, projecting (projecting) light including an image on a displayable area A1. The displayable area A1 is an area included in a part of the front windshield 20 in front of the driver's seat 40. In the following description, the virtual image may be referred to as an “image” in some cases.

The display device 100 causes the driver to visually recognize an image including, for example, information for supporting driving of the driver or information on a predetermined event as a virtual image IV. The information for supporting the driving of the driver may include, for example, information such as a speed of the vehicle M, a driving power distribution ratio, engine revolutions, an operation state shift position of a driving support function, a sign recognition result, an intersection point position, and the like. The driving support function is, for example, a direction indication function, an adaptive cruise control (ACC), a lane keep assist system (LKAS), a collision mitigation brake system (CMBS), a traffic jam assist function, or the like.

In addition to the display device 100, the vehicle M may be provided with a first displayer 50-1 and a second displayer 50-2. The first displayer 50-1 is a display device. The first displayer 50-1 is provided, for example, in the vicinity of the front of the driver's seat 40 in the instrument panel 30. The first displayer 50-1 is able to be visually recognized by the driver from a gap of the steering wheel 10 or is able to be visually recognized through the steering wheel 10. The second displayer 50-2 is attached to, for example, a central portion of the instrument panel 30. The second displayer 50-2 displays, for example, an image associated with a navigation process performed by a navigation device (not shown) mounted on the vehicle M, or a video of the other party in a videophone or the like. The second displayer 50-2 may display a television program, reproduce a DVD, or display contents such as a downloaded movie.

The vehicle M is provided with an operation switch (an example of an operator) 130 that receives an instruction to switch on/off the display by the display device 100 or an instruction to adjust a position of the virtual image VI. The operation switch 130 is attached, for example, to a position where the driver sitting on the driver's seat 40 is able to operate without greatly changing a posture. The operation switch 130 may be provided, for example, in front of the first displayer 50-1, or may be provided on a boss portion of the steering wheel 10. The operation switch 130 may be provided on a spoke that connects the steering wheel 10 and the instrument panel 30 with each other.

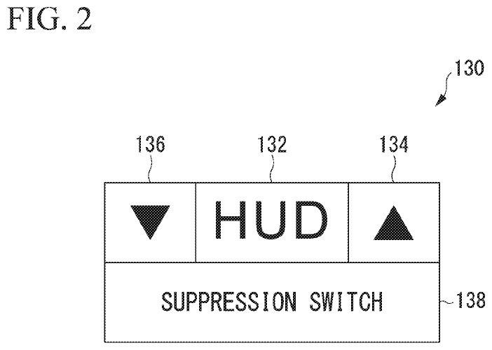

FIG. 2 is a diagram showing the operation switch 130 of the embodiment. The operation switch 130 includes, for example, a main switch 132, an adjustment switch 134, an adjustment switch 136, and a suppression switch 138. The main switch 132 is a switch that switches on/off of the display device 100.

The adjustment switch 134 is, for example, a switch for receiving an instruction to move the position of the virtual image VI to an upper side (hereinafter, referred to as an upward direction) with respect to a vertical direction Z. The position of the virtual image VI is a position that is visually recognized as being in a space transmitted through the front windshield 20 from a line of sight position P1 of the driver. The driver is able to continuously move the visually recognized position of the virtual image VI in the upward direction in the displayable area A1 by continuously pressing the adjustment switch 134.

The adjustment switch 136 is a switch for receiving an instruction to move the position of the virtual image VI described above to a lower side (hereinafter, referred to as a downward direction) with respect to the vertical direction Z. The driver is able to continuously move the visually recognized position of the virtual image VI in the downward direction in the displayable area A1 by continuously pressing the adjustment switch 136.

The adjustment switch 134 may be a switch for increasing a brightness of the virtual image VI to be visually recognized instead of (or in addition to) moving the position of the virtual image VI in the upward direction. The adjustment switch 136 may be a switch for reducing the brightness of the virtual image VI to be visually recognized instead of (or in addition to) moving the position of the virtual image VI in the downward direction. The contents of the instruction received by the adjustment switches 134 and 136 may be switched on the basis of a certain operation. The certain operation is, for example, a long press operation of the main switch 132. In addition to the switches shown in FIG. 2, the operation switch 130 may include, for example, a switch for selecting display content or a switch for adjusting the brightness of the virtual image to be exclusively displayed.

The suppression switch 138 is a switch for receiving a suppression instruction for suppressing an output frequency of the image by the occupant (viewer) of the vehicle.

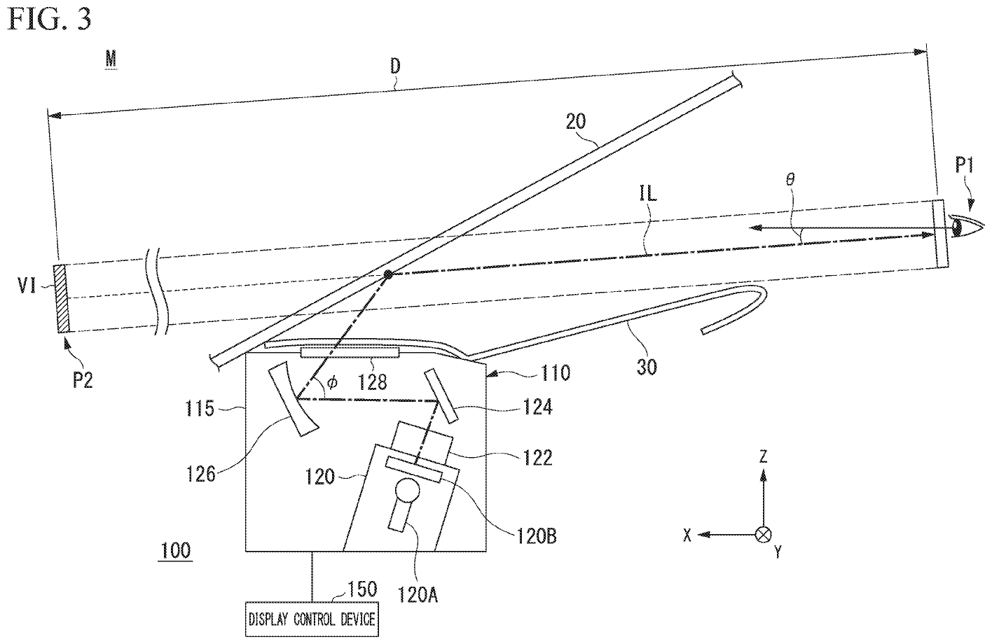

FIG. 3 is a partial constitution diagram of the display device 100. The display device 100 includes, for example, a display 110 and a display control device (an example of a controller) 150. The display 110 includes, for example, a housing 115. A light projection device 120, an optical mechanism 122, a plane mirror 124, a concave mirror 126, and a light transmission cover 128 are accommodated in the housing 115. In addition to these, the display device 100 includes various sensors and actuators, which will be described later. The display device 100 may have a constitution in which the optical mechanism 122 is not provided.

The light projection device 120 includes, for example, a light source 120A and a display element 120B. The light source 120A is, for example, a cold cathode tube, and outputs visible light associated with the virtual image VI to be visually recognized by the driver. The display element 120B controls transmission of the visible light output by the light source 120A. The display element 120B is, for example, a liquid crystal display (LCD) of a thin film transistor (TFT) type. Each of a plurality of pixels included in the display element 120B is controlled, and a transmission degree of the visible light output to the light source 120A for each color element is controlled. Therefore, a form (look) of the virtual image IV is determined. Hereinafter, the visible light transmitted through the display element 120B and including the image is referred to as image light IL. In a case in which the display element 120B is an organic EL display, the light source 120A may be omitted.

The optical mechanism 122 is provided on the path of the light output from the light projection device 120. The optical mechanism 122 adjusts the distance from the predetermined position to the position where the light is formed as the virtual image. The optical mechanism 122 includes, for example, one or more lenses. The position of each lens is able to be adjusted, for example, in an optical axis direction. The optical mechanism 122 is provided, for example, on a path of the image light IL output from the light projection device 120. The optical mechanism 122 passes the image light IL incident from the light projection device 120 and emits the image light IL toward the front windshield 20. The optical mechanism 122 is able to adjust, for example, a distance (hereinafter referred to as a virtual image visual recognition distance D) from a line of sight position P1 of the driver to a formation position P2 where the image light IL is formed as the virtual image by changing the position of the lens. The line of sight position P1 of the driver is a position where the image light IL is collected by being reflected by the concave mirror 126 and the front windshield 20, and is a position where it is assumed that the eyes of the driver are present. The virtual image visual recognition distance D is strictly a distance of a line segment having an inclination in the vertical direction, but the distance may mean a horizontal distance. In the following description, in a case in which it is expressed that “the virtual image visual recognition distance D is 7 [m]” or the like, the distance may be the distance of the line segment described above or may be the distance in the horizontal direction.

In the following description, a depression angle θ is defined as a formation angle. The formation angle is an angle formed by a horizontal plane passing through the line of sight position P1 and the line segment from the line of sight position P1 of the driver to the formation position P2. The more the virtual image VI is formed downward, that is, the more downward the line of sight direction at which the driver views the virtual image VI, the larger the depression angle θ. The depression angle θ is determined on the basis of a reflection angle φ of the concave mirror 126 and a display position of an original image on the display element 120B as described later. The reflection angle φ is an angle formed by an incident direction in which the image light IL reflected by the plane mirror 124 enters the concave mirror 126 and an emission direction in which the concave mirror 126 emits the image light IL.

The plane mirror 124 reflects the visible light (that is, the image light IL) emitted by the light source 120A and having passed through the display element 120B in a direction of the concave mirror 126.

The concave mirror 126 reflects the image light IL incident from the plane mirror 124 and emits the image light IL toward the front windshield 20. The concave mirror 126 is supported so as to be rotatable (pivotable) about a Y axis that is an axis in a width direction of the vehicle M.

The light transmission cover 128 transmits the image light IL guided by the concave mirror 126 to cause the image light IL to reach the front windshield 20, and suppresses an entry of a foreign matter such as dust, dirt, or a water droplet into the housing 115. The light transmission cover 128 is provided with an opening formed in an upper member of the housing 115. The instrument panel 30 is also provided with an opening or a light transmission member, and the image light IL passes through the light transmission cover 128 and is transmitted through the opening of the instrument panel IP or the light transmission member to be reached the front windshield 20.

The image light IL incident to the front windshield 20 is reflected by the front windshield 20 and condensed at the line of sight position P1 of the driver. At this time, the driver feels that the virtual image (image) captured by the image light IL is displayed in front of the vehicle M.

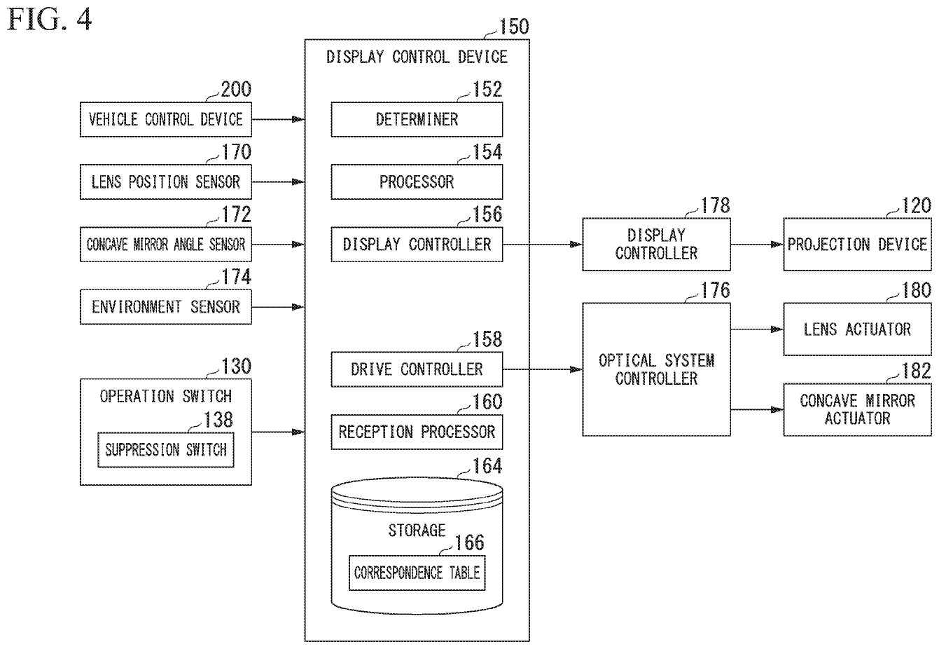

The display control device 150 controls the display of the virtual image VI to be visually recognized by the driver. FIG. 4 is a diagram showing a constitution example of the display device 100 centering on the display control device 150. In an example of FIG. 4, in addition to the display control device 150, a lens position sensor 170, a concave mirror angle sensor 172, an environment sensor 174, an optical system controller 176, a display controller 178, a lens actuator (an example of a first actuator) 180, a concave mirror actuator (an example of a second actuator) 182, and the light projection device 120, which are included in the display device 100 are shown.

The lens position sensor 170 detects a position of one or more lenses included in the optical mechanism 122. The concave mirror angle sensor 172 detects a rotation angle of the concave mirror 126 about the Y axis shown in FIG. 3 described above. The environment sensor 174 detects, for example, a temperature of the light projection device 120 or the optical mechanism 122. The environment sensor 174 may detect an illuminance around the vehicle M, detect a speed of the vehicle M and a steering angle, or detect an object (for example, an obstacle such as another vehicle or a pedestrian) present in the vicinity.

The optical system controller 176 adjusts the virtual image visual recognition distance D by driving the lens actuator 180 on the basis of a control signal output by the drive controller 158. The optical system controller 176 drives the concave mirror actuator 182 on the basis of the control signal output by the drive controller 158 to adjust the rotation angle of the concave mirror 126.

The display controller 178 controls the content and display mode of the image output by the light projection device 120. The display mode of the image is, for example, a luminance, a display position, a size, and the like.

The lens actuator 180 acquires a drive signal output by the optical system controller 176, drives a motor or the like on the basis of the acquired drive signal, and moves the position of one or more lenses included in the optical mechanism 122. Therefore, the virtual image visual recognition distance D is adjusted.

The concave mirror actuator 182 acquires the drive signal output by the optical system controller 176, drives a motor or the like on the basis of the acquired drive signal, rotates the concave mirror actuator 182 about the Y axis, and adjusts the reflection angle φ of the concave mirror 126. Therefore, the depression angle θ is adjusted.

[Display Control Device]

The display control device 150 includes, for example, a determiner 152, a processor 154, a display controller 156, a drive controller 158, a reception processor 160, and a storage 164. Each of these components is implemented, for example, by a hardware processor such as a central processor (CPU) executing a program (software). Some or all of these components may be implemented by hardware (a circuit; including a circuitry) such as a large scale integration (LSI), an application specific integrated circuit (ASIC), a field-programmable gate array (FPGA), and a graphics processing unit (GPU) or may be implemented by a cooperation of software and hardware. The program may be stored in advance in a storage device (not shown) such as a HDD or a flash memory of the display control device 150, stored in a removable storage medium such as a DVD or a CD-ROM, or may be installed in the HDD or the flash memory of the display control device 150 by attachment of a storage medium to the drive device.

The storage 164 is realized by, for example, a storage device such as a random access memory (RAM), a read only memory (ROM), a hard disk drive (HDD), or a flash memory. The storage 164 stores, for example, a correspondence table 166.

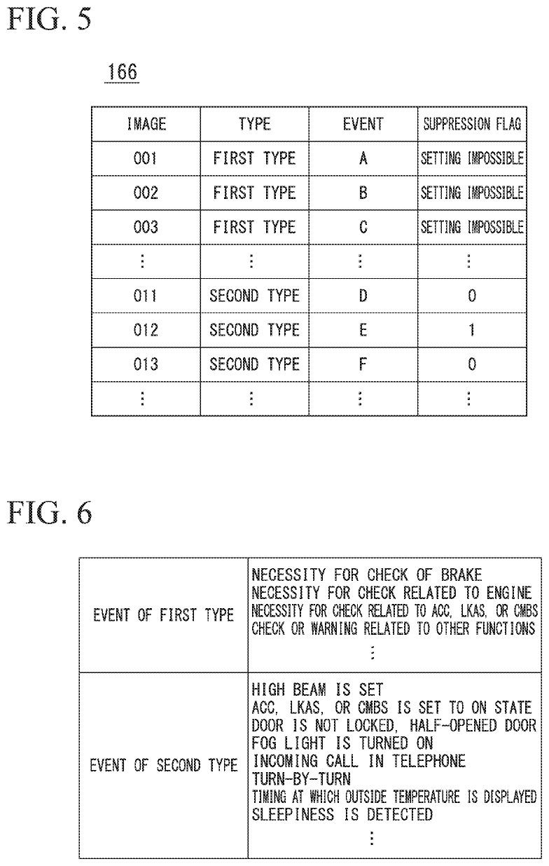

FIG. 5 is a diagram showing an example of a content of the correspondence table 166. The correspondence table 166 is information in which an image, a type of an event, the event, and a setting state of a suppression flag are associated with one another. The image is an image provided to the occupant by the display device 100. The type includes, for example, a first type and a second type. The first type is, for example, a type in which the suppression flag is not able to be set, and the second type is a type in which the suppression flag is able to be set. The suppression flag is, for example, a flag indicating suppression of the output frequency of causing the display device 100 to output an image. In the shown example, for example, “1” is a state in which the suppression flag is set, and “0” is a state in which the suppression flag is not set.

In the following description, although an output is described as being zero as an example of suppressing the “output frequency”, instead of this, the number of times of displaying an image may be reduced. Reducing the number of times includes, for example, an image is output only one of events in a case in which an event occurs twice or an image is output at a predetermined time interval. Instead of “suppressing the output frequency”, “display mode may be changed”. Changing the display mode is, for example, changing to a display mode that reduces a visibility for the occupant. Reducing the visibility includes, for example, reducing the brightness of the image, or changing the position at which the image is displayed to a position where it is difficult for the occupant to view (a position of a downward direction).

The event is an event that occurs due to a state of the vehicle. FIG. 6 is a diagram showing an example of an event of the first type and an event of the second type. The event of the first type is a so-called interrupt display of information related to safety and regulations. For example, the event of the first type is necessity for a check related to a predetermined function or a generation of a warning, such as necessity for a check of a brake, necessity for a check of an engine, a fact that a distance to a preceding vehicle becomes a threshold value or less, and necessity for a check of the ACC, LKAS or CMBS.

The event of the second type is a so-called interruption display of information related to merchantability, and is an event that is relatively less important than the event of the first type. The event of the second type includes, for example, facts that headlight is set to high beam, the ACC, LKAS, or CMBS is set to an on state, a door is not locked, the door is not completely closed, fog light is turned on, there is an incoming call in a telephone function mounted on the vehicle, reception of a mail occurs in a mail transmission and reception function of a terminal device mounted on the vehicle, and reception of information occurs in a reception function of information such as news of the terminal device mounted on the vehicle, approaching a timing to turn to the left or right for heading to a destination set in a navigation device, approaching a branch road for a destination, a timing to display an outside temperature that is set in advance, and the like.

Next, each functional unit will be described. On the basis of the information acquired from the vehicle control device 200, the determiner 152 determines whether or not the drive source of the vehicle is controlled to be in the on state or whether or not a preset event has occurred.

The processor 154 refers to the correspondence table 166 to specify the type of the event and the image according to the type of the event. The processor 154 determines whether or not the suppression flag is set with respect to the specified image.

The display controller 156 causes the display 110 to output an event image associated with the event at a predetermined event occurrence timing, and in a case in which the suppression switch 138 receives a suppression instruction, the output of the event image by the display 110 is suppressed. In a predetermined period, in a case in which the number of times the suppression switch 138 receives the suppression instruction in accordance with causing the display 110 to output the event image reaches first number of times, the display controller 156 suppresses the output frequency of causing the display 110 to output the event image regardless of the presence or absence of the operation received by the suppression switch 138. The predetermined period is a period from a time when the drive source (for example, an engine) of the vehicle is controlled to be in the on state to a time when the drive source is controlled to be in the off state, or a period from the time when the drive source is controlled to be in the on state to a time when a predetermined time (for example, several tens of minutes) elapses from the time when the drive source is controlled to be in the off state. The predetermined period may be a period from a time when power supply of the vehicle is in the on state (for example, an accessory on state) to a time when the power supply of the vehicle is in the off state.

The drive controller 158 generates a control signal (first control signal) for moving the position of one or more lenses included in the optical mechanism 122 or a control signal (second control signal) for adjusting the rotation angle of the concave mirror 126 on the basis of the control information by the display controller 156, and outputs the generated control signals to the optical system controller 176. The drive controller 158 generates the first control signal or the second control signal on the basis of the lens position detected by the lens position sensor 170 and the reflection angle φ of the concave mirror 126 detected by the concave mirror angle sensor 172 so that the virtual image VI including the image at the position instructed by the display controller 156 is to be visually recognized or the virtual image VI including the image at the virtual visual recognition distance D is to be visually recognized, and outputs the generated control signal to the optical system controller 176.

The drive controller 158 adjusts the position of the virtual image VI or the virtual image visual recognition distance D on the basis of the operation content received by the operation switch 130. For example, in a case in which the operation of the adjustment switch 134 is received, the drive controller 158 outputs, to the optical system controller 176, the first control signal for moving the position of the virtual image VI upward in the displayable area A1. In a case in which the operation of the adjustment switch 136 is received, the drive controller 158 outputs, to the optical system controller 176, the first control signal for moving the position of the virtual image VI downward in the displayable area A1.

The reception processor 160 receives the suppression instruction performed on the suppression switch 138.

The vehicle control device 200 controls the vehicle or acquires detection results of various sensors mounted on the vehicle. For example, the vehicle control device 200 executes a driving support function that supports the driving of the driver of the vehicle M. In a case in which the driving support function is executed, for example, the vehicle M controls one or both of steering control or speed control without depending on an operation of a driving operation element (for example, a steering wheel 10, an accelerator pedal, and a brake pedal) by the driver. For example, when executing the ACC as the driving support function, the driving support control device 200 performs acceleration and deceleration control (speed control) based on an inter-vehicle distance from the preceding vehicle so that the vehicle travels in a state in which the inter-vehicle distance between the vehicle and the preceding vehicle keeps constant on the basis of information input through an object recognition device (not shown) mounted on the vehicle M. When executing the LKAS as the driving support function, the vehicle control device 200 performs the steering control so that the vehicle M travels while maintaining a current traveling lane (lane keeping). When executing the CMBS as the driving support function, the vehicle control device 200 performs deceleration control or stop control of the vehicle M in a case in which the inter-vehicle distance with the preceding vehicle is less than a predetermined distance. The vehicle control device 200 outputs, for example, a state of the driving support function to the display control device 150. The vehicle control device 200 outputs, to the display control device 150, information (warning information) for warning the driver before executing the LKAS or the CMBS. The warning information is, for example, a lane departure warning, a forward approaching vehicle warning, and the like.

[Process Flow]

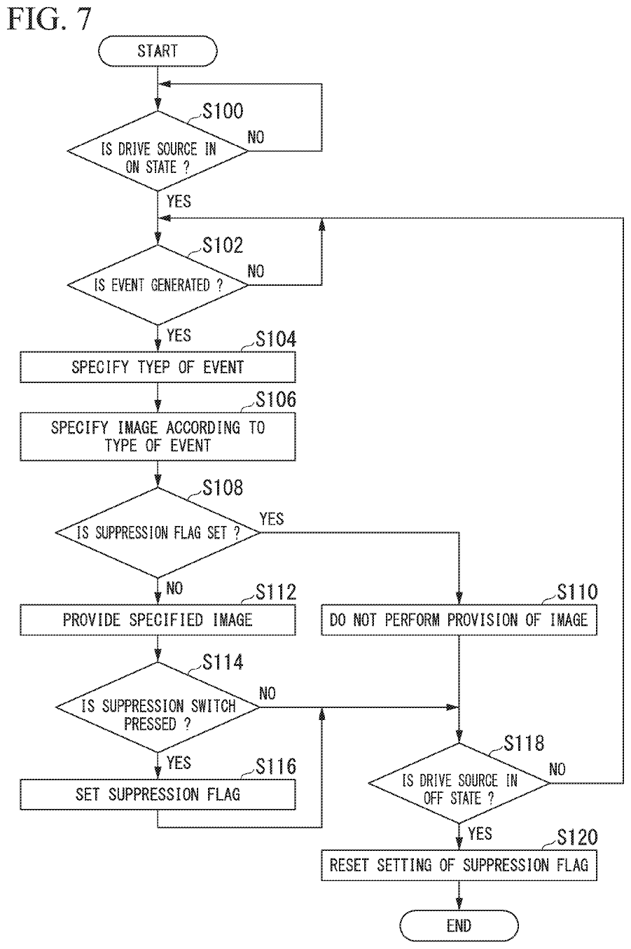

FIG. 7 is a flowchart showing a flow of a process executed by the display device 100 of the embodiment.

First, the determiner 152 determines whether or not the drive source of the vehicle is controlled to be in the on state on the basis of the information acquired from the vehicle control device 200 (step S100). In a case in which the drive source of the vehicle is controlled to be in the on state, the determiner 152 determines whether or not the event has occurred on the basis of the information acquired from the vehicle control device 200 (step S102).

In a case in which the event has occurred, the processor 154 specifies the type of the event (step S104). Next, the processor 154 specifies the image according to the specified type of the event with reference to the correspondence table 166 (step S106).

Next, the processor 154 determines whether or not the suppression flag is set with respect to the image specified in step S106 with reference to the correspondence table 166 (step S108).

In a case in which the suppression flag is set, the display controller 156 proceeds to a process of step S118 without providing the image to the occupant (step S110). In a case in which the suppression flag is not set, the display controller 156 provides the image specified in step S106 to the occupant (step S112).

Next, the processor 154 determines whether or not the reception processor 160 is received information indicating that the suppression switch 138 is pressed (step S114). In a case in which the information indicating the pressure of the suppression switch 138 is not received, the process proceeds to the process of step S118. In a case in which the information indicating the pressure of the suppression switch 138 is received, the processor 154 sets the suppression flag in association with the image provided in step S112 in the correspondence table 166 (step S116).

Next, the determiner 152 determines whether or not the drive source of the vehicle is controlled to be in the off state on the basis of the information acquired from the vehicle control device 200 (step S118). In a case in which the drive source of the vehicle is not controlled to be in the off state, the process returns to step S102. In a case in which the drive source of the vehicle is controlled to be in the off state, the processor 154 resets the suppression flag set in the correspondence table 166 (step S120). Therefore, the process of the present flowchart is ended.

As described above, it is possible to reduce the troublesomeness of the occupant. Since information of high importance to be notified to the occupant is displayed, the convenience of the user is improved.

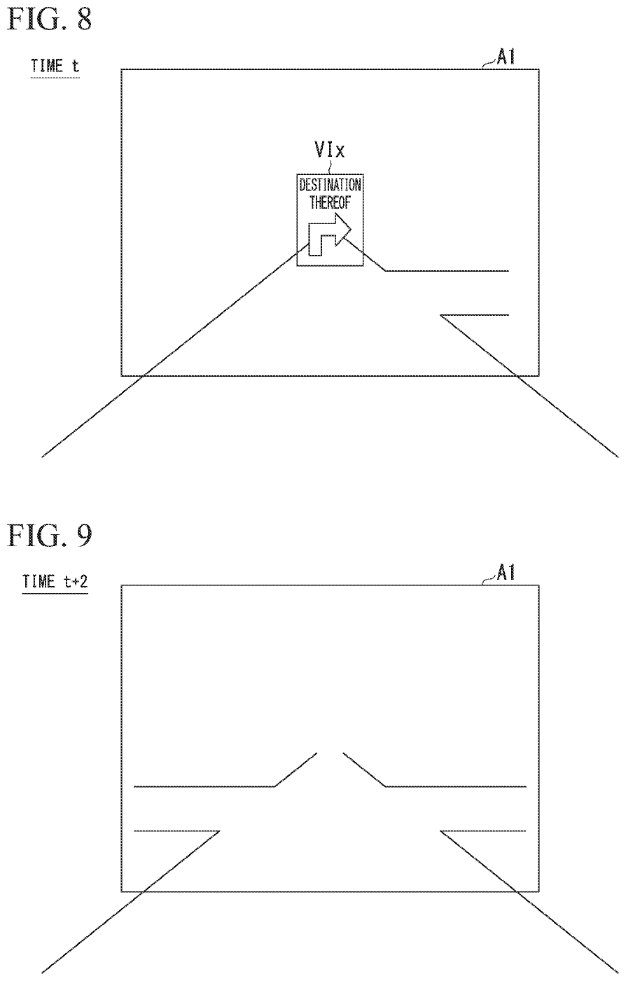

The display aspect before and after the suppression instruction is performed on the event of the second type will be described with reference to FIGS. 8 and 9. FIG. 8 is a diagram showing an example of a guidance image VIx displayed in the displayable area A1 before the suppression instruction is performed (before the suppression flag is set) at the time of the event of the second type. The guidance image VIx is, for example, an image showing turn-by-turn. The guidance image VIx is an image displayed when approaching timing to turn to the left or right for heading to a destination set in the navigation device, or approaching a branch road heading to the destination. In the example of FIG. 8, at a time t, a turn-by-turn event that displays the guidance image is generated, and the guidance image VIx that indicates turning to the right to guide the vehicle M to the destination is displayed.

At a time t+1, which is a predetermined time from the time t, it is assumed that the suppression instruction is performed by the occupant. In addition, in a case in which the turn-by-turn event occurs at a time t+2, the guidance image VIx is originally displayed, but since the suppression instruction is performed, the guidance image VIx is not displayed as shown in FIG. 9. As described above, it is possible to suppress the display that the occupant feels troublesome.

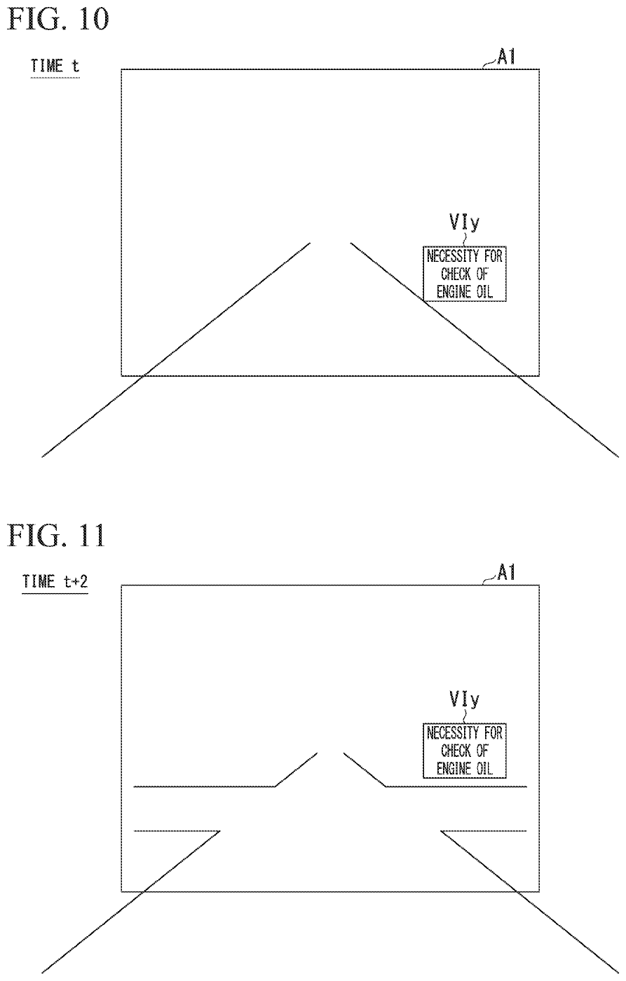

The display aspect before and after the suppression instruction is performed on the event of the first type will be described with reference to FIGS. 10 and 11. FIG. 10 is a diagram showing an example of an inspection image VIy displayed in the displayable area A1 before the suppression instruction is performed at the time of the event of the first type. The inspection image VIy is, for example, an image showing inspection of engine oil. In the example of FIG. 10, at a time t, an inspection event for displaying the inspection image occurs, and the inspection image VIy is displayed in the displayable area A1.

At a time t+1, that is a predetermined time from the time t, it is assumed that the suppression instruction is performed by the occupant. In addition, the inspection event occurs at a time t+2, the suppression instruction is performed, but the inspection image VIy is displayed as shown in FIG. 11. As described above, the display of the information of high importance to be notified to the occupant is not suppressed. As a result, the convenience of the user is improved.

According to the first embodiment described above, in the predetermined period, in a case in which the number of times the suppression switch 138 receives the suppression instruction according to the timing at which the display 110 is caused to output the event image associated with the event of the first type at a timing at which the event of the first type occurs reaches the first number of times, the display controller 156 controller does not suppress the output frequency of causing the display 110 to output the event image associated with the event of the first type regardless of the presence or absence of the operation received by the suppression switch 138, and in the predetermined period, in a case in which the number of times the suppression switch 138 receives the suppression instruction according to the timing at which the display 110 is caused to output the event image associated with the event of the second type at a timing at which the event of the second type occurs reaches the first number of times, the display controller 156 suppresses the output frequency of causing the display 110 to output the event image associated with the event of the second type. As a result, it is possible to reduce the troublesomeness of the occupant.

### Second Embodiment

The second embodiment will be described. In the second embodiment, conditions for setting the suppression flag are different for each event. Hereinafter, differences from the first embodiment will be mainly described.

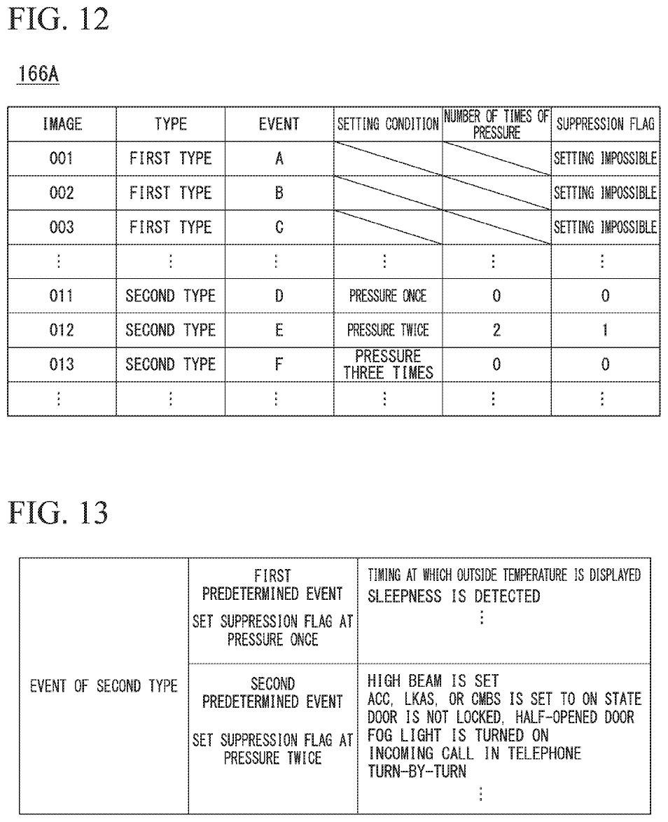

The storage 164 of the second embodiment stores, for example, a correspondence table 166A. FIG. 12 is a diagram showing an example of a content of the correspondence table 166A. In the correspondence table 166A, in addition to the contents of the correspondence table 166, a condition under which a suppression flag is set with respect to an image and the number of times the suppression switch 138 is pressed so far are associated with each other. The condition under which the suppression flag is set is, for example, the number of times the suppression switch 138 is pressed.

For example, the conditions under which the suppression flag is set are different for each type of the event included in the event of the second type. For example, a first predetermined event is an event in which the suppression flag is set in a case in which the suppression switch 138 is pressed Na times (for example, once). For example, a second predetermined event is an event in which the suppression flag is set in a case in which the suppression switch 138 is pressed Nb times (for example, twice). It is an event of high importance in the order of the second predetermined event and the first predetermined event. In addition to the events described above, the event may include a third predetermined event in which the suppression flag is set in a case in which the suppression switch 138 is pressed Nc times (for example, three times).

FIG. 13 is a diagram showing an example of the first predetermined event and the second predetermined event. The first predetermined event is, for example, a timing at which a preset outside temperature is displayed, detection of sleepiness by a sleepiness detection device mounted on the vehicle, or the like.

The second predetermined event is, for example, a fact that headlight is set to high beam, the ACC, LKAS, or CMBS is set to an on state, a door is not locked, the door is not completely closed, fog light is turned on, or there is an incoming call in a telephone function mounted on the vehicle, approaching a timing to turn to the left or right for heading to a destination set in a navigation device, approaching a branch road for a destination, or the like.

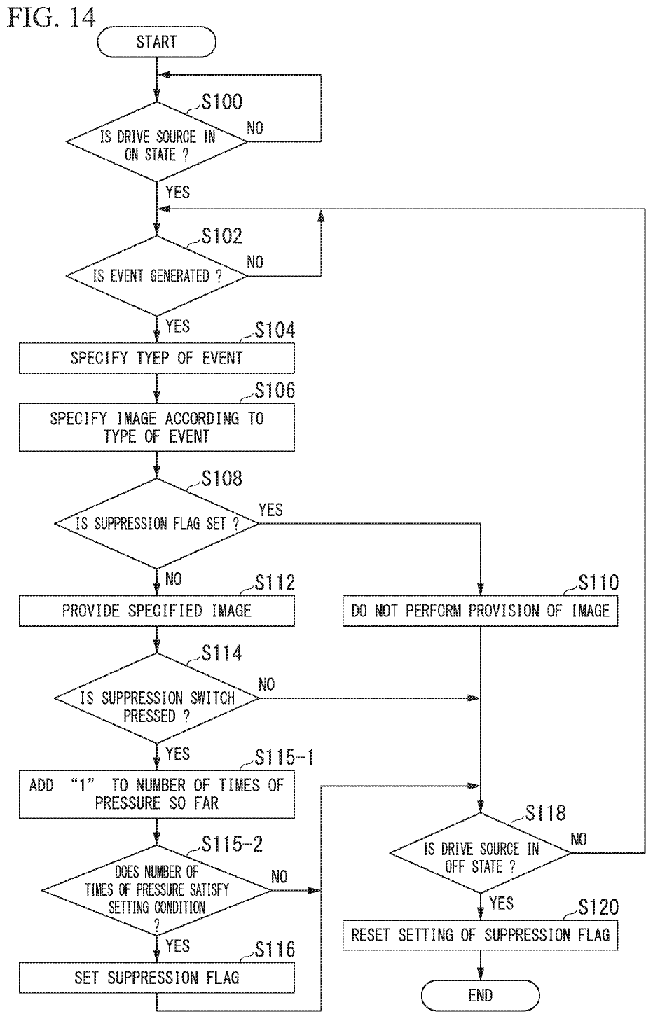

FIG. 14 is a flowchart showing a flow of a process executed by the display device 100 of the second embodiment. The differences from the process of FIG. 6 of the first embodiment will be mainly described.

In a case in which the suppression switch 138 is pressed in the process of step S114, the processor 154 adds “1” to the number of times of the pressure associated with the event image provided in step S112 in the correspondence table 166A (step S115-1). Next, the processor 154 determines whether or not the number of times of the pressure so far satisfies the setting condition (step S115-2). In a case in which the number of times of the pressure so far satisfies the setting condition, the processor 154 sets the suppression flag in the correspondence table 166A (step S116). In a case in which the number of times of the pressure so far does not satisfy the setting condition, the process proceeds to step S118.

According to the second embodiment described above, the display controller 156 counts the number of times the suppression instruction is received for each event image, and in a case in which the counted number reaches the first number of times set for each event image, the display controller 156 suppresses the output frequency of causing the display 110 to output the event image. As a result, it is difficult to suppress the output frequency of the information of high importance. As a result, it is possible to enable the occupant to more reliably recognize the information of high importance.

Although the display device 100 is described as performing the process of suppressing the occurrence of the event image by pressing the suppression switch 138, instead of (or in addition to) this, the process of suppressing the occurrence of the event image may be performed on the basis of a predetermined gesture performed by the occupant, a movement of a line of sight of the occupant, or the like. In this case, for example, the display device 100 includes an image processor and an in-vehicle camera. In addition, the image processor compares an image captured by the in-vehicle camera with a template stored in the storage device in advance, and determines whether or not to suppress the occurrence of the event image on the basis of a comparison result.

Instead of projecting the image directly on the front windshield 20, the display device 100 may project the image on a light transmissive reflective member such as a combiner provided between the position of the driver and the front windshield 20.

According to the embodiments described above, the display device 100 includes an image generator (110) configured to output an image, superimpose the image on a landscape, and allow a viewer to visually recognize the image, a receiver (138) configured to receive a suppression instruction for suppressing an output frequency of the image, and a controller (150, 156) configured to cause the image generator to output an event image associated with an event at a timing at which a predetermined event occurs, and suppress the output of the event image by the image generator in a case in which the receiver receives the suppression instruction. In a predetermined period, in a case in which the number of times the receiver receives the suppression instruction causing the image generator to output the event image reaches first number of times, the controller suppresses the output frequency of causing the image generator to output the event image regardless of presence or absence of an operation received by the receiver. Therefore, it is possible to reduce the troublesomeness of the occupant.

While preferred embodiments of the invention have been described and illustrated above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A display device comprising:
an image generator configured to output an image, superimpose the image on a landscape, and allow a viewer to visually recognize the image;
a receiver configured to receive a suppression instruction for suppressing an output frequency of the image; and
a controller configured to cause the image generator to output an event image associated with an event at a timing at which a predetermined event occurs, and suppress the output of the event image by the image generator in a case in which the receiver receives the suppression instruction,
wherein, in a predetermined period, in a case in which the number of times the receiver receives the suppression instruction causing the image generator to output the event image reaches first number of times, the controller suppresses the output frequency of causing the image generator to output the event image regardless of presence or absence of an operation received by the receiver.

2. The display device according to claim 1,
wherein the image generator is configured to generate the image that is visually recognized by the viewer by outputting light forming the image by directing incident light toward a reflector is configured to reflect the light toward eyes of the viewer.

3. The display device according to claim 2,
wherein the controller is configured to refer to correspondence information in which different event images are associated with each of a plurality of types of the events, and causes the image generator to output an event image associated with the type of the generated event, and
the number of times the suppression instruction is received is counted for each event image.

4. The display device according to claim 1,
wherein the first number of times is different for each event image.

5. The display device according to claim 1,
wherein the event includes an event of a first type and an event of a second type, different event images are associated with each type of the event,
in the predetermined period, in a case in which the number of times the receiver receives the suppression instruction according to a first timing at which the image generator is caused to output the event image associated with the event of the first type at a timing at which the event of the first type occurs reaches the first number of times, the controller does not suppress the output frequency of causing the image generator to output the event image associated with the event of the first type regardless of the presence or absence of the operation received by the receiver, and
in the predetermined period, in a case in which the number of times the receiver receives the suppression instruction according to a second timing at which the image generator is caused to output the event image associated with the event of the second type at a timing at which the event of the second type occurs reaches the first number of times, the controller suppresses the output frequency of causing the image generator to output the event image associated with the event of the second type.

6. The display device according to claim 1,
wherein the predetermined period is a period from when a drive source of a vehicle is controlled to be in an on state to when the drive source is controlled to be in an off state, or a period from the time when the drive source is controlled to be in the on state to when a predetermined time elapses from the time when the drive source is controlled to be in the off state.

7. The display device according to claim 1,
wherein the image generator comprises:
a projection device configured to output the image as light;
an optical mechanism provided on a path of the light and capable of adjusting a distance from a predetermined position to a position where the light is formed as a virtual image;
a concave mirror configured to reflect light passing through the optical mechanism toward a reflector;
a first actuator configured to adjust the position where the light is formed in the optical mechanism; and
a second actuator configured to adjust a reflection angle of the concave mirror.

8. A display control method using a computer, the computer method comprising:
causing an image generator to output an image, superimpose the image on a landscape, and allow a viewer to visually recognize the image to output an event image associated with an event at a timing at which a predetermined event occurs;
suppressing the output of the event image by the image generator in a case in which a receiver that receives a suppression instruction for suppressing an output frequency of the image receives the suppression instruction; and
suppressing the output frequency of causing the image generator to output the event image regardless of presence or absence of an operation received by the receiver, in a case in which the number of times the receiver receives the suppression instruction causing the image generator to output the event image reaches first number of times, in a predetermined period.

9. A non-transitory computer-readable storage medium that stores a computer program to be executed by a computer to perform at least:
cause an image generator to output an image, superimpose the image on a landscape, and allow a viewer to visually recognize the image to output an event image associated with an event at a timing at which a predetermined event occurs;
suppress the output of the event image by the image generator in a case in which a receiver that receives a suppression instruction for suppressing an output frequency of the image receives the suppression instruction; and
suppress the output frequency of causing the image generator to output the event image regardless of presence or absence of an operation received by the receiver, in a case in which the number of times the receiver receives the suppression instruction causing the image generator to output the event image reaches first number of times, in a predetermined period.
